(19) United States
(12) Patent Application Publication
(10) Pub. No.: US 2009/0017199 A1
(43) Pub. Date: Jan. 15, 2009

(54) Clear-coat scratch repair composition and refinishing process

(76) Inventor: Alex Kotyakov, Port Coquitlam (CA)

Correspondence Address: c/o Paul D. Gornall;Barrister & Solicitor; Reg'd Patent & TM Agent, 1820 - 355 Burrard St., Vancouver, BC, V6C 2G8, CA

(21) Appl. No.: 11/825,730

(22) Filed: Jul. 10, 2007

(51) Int. Cl. B05D 3/00; B32B 43/00; C04B 28/36

(52) U.S. Cl. 427/140; 106/287.23

(57) ABSTRACT

The present invention discloses a composition and method for repairing scratches to vehicles and other products which have clear-coat finishes. The composition contains a clear-coat combined with a reducer, to which a hardener is added before application. The threshold proportions of the composition are critical to the composition's effectiveness as they produce a long drying time and a fast cure time. This enables the composition to be worked-into the clear-coat surface for sufficient time to obtain excellent coverage, and to cure quickly after it is applied. The composition can be reapplied as often as desired.

### FIELD OF THE INVENTION

The present invention relates generally to paint processes, and particularly for repairing light scratches to articles such as vehicles which have clear-coat finishes.

### BACKGROUND OF THE INVENTION

A wide variety of methods exist for repairing scratches to vehicles. These methods vary based on the size and depth of the scratch. Deep scratches will require the use of color-matched touchup paint and are generally done by professionals. Amateur car enthusiasts can purchase do-it-yourself kits for repairing more superficial scratches.

Those scratches that do not extend deeper than the clear-coat are commonly referred to as “light scratches”. Depending on the extent of damage to the clear-coat, these light scratches may be repaired by cleaning and applying polisher. If the damage to the clear-coat is more extensive, rubbing off the damaged portion of the clear-coat and refinishing using clear-coat formula may be required. In terms of commonalities, virtually all methods involve an initial cleaning step which involves either rubbing or the application of an abrasive chemical, and a stage in which a finish is added, either a clear-coat finish, or simply a polish.

Many different compositions are used for repairing scratches and refinishing clear-coat surfaces. Prior compositions were less than optimal because they either dried to quickly, or cured too slowly. Those compositions which dry too quickly often result in an imperfect refinishing job because insufficient time was available for application. This requires extensive and labour intensive rebuffing at a later stage. If drying time is exceeded in application of a clear-coat-based composition, then lifting of paint can result. Other compositions had a longer drying time, but also had a longer curing time, often several weeks. One reason for these problems is that drying time and curing time tend to be positively correlated in clear-coating products, possibly due to the hardening agent being added beforehand or to the relative proportions of the ingredients in these compositions.

### SUMMARY OF THE INVENTION

The present invention solves the problems of insufficient time for application and excessive curing time. It involves a method for removing scratches using a composition comprising clear-coat, reducer, and hardener components. The properties of the clear-coat, reducer, and hardener when mixed in the right sequence and proportions yield a composition with threshold emergent properties which make it ideal in terms of both drying time and curing time. The composition dries relatively slowly and cures relatively quickly. This enables the composition to be worked-into the clear-coat surface for sufficient time to obtain excellent coverage, and to cure quickly after it is applied. The slow drying time also prevents the paint-lifting that can result with other paint repair products which are difficult to apply properly during the drying time. The composition can be applied and reapplied as often as necessary to obtain desired refinishing results.

The composition derives its useful properties from the specific proportions of the ingredients of the mixture, which in a preferred embodiment are: 13.6% clear-coat, 79.2% reducer, and 7.20% hardener with the components of the ingredients being as in these examples in the following ranges:

Clear-coat: butyl benzyl phthalate (1-5%), methyl n-amyl ketone (30-40%), xylene (1-10%), light stabilizer (1-3%), ethyl 3-ethoxy propionate (1-5%), acetone (1-10%), and ethyl benzene (<1%).
Reducer: toluene (40-50%), ethyl benzene (5-15%), xylene (35-45%), and ethyl 3-ethoxy propionate (5-15%).
Hardener: methyl amyl ketone (25-35%), hexamethylene diisocyanate monomer (<1.0%), and hexamethylene diisocyanate polyisocyanate (65.0-75.0%).

The invention provides a method for repairing scratches and for refinishing clear-coat surfaces, which employs a special composition comprising a clear-coat, a reducer, and a hardener in specific proportions, comprising the following steps:

a) wash and dry clear-coat surface with diluted car wash and a first absorbent towel;
b) further clean the clear-coat surface by rubbing-in lacquer thinner;
c) mix the clear-coat and the reducer in a volume ratio of approximately 6 to 35 respectively;
d) immediately prior to application, add the hardener to the above mixture in a volume ratio of approximately 9 units hardener to 116 units of the above mixture;
e) apply the resulting composition to the clear-coat surface using a second absorbent towel;
f) allow to dry;
g) determine whether the scratch is still visible;
h) repeat if necessary.

Useful ranges for the composition are clear-coat, reducer, and hardener in the following proportions: between 12.2% and 14.9% clear-coat; between 71.3% and 87.1% reducer; between 6.5% and 7.9% hardener.

### BRIEF DESCRIPTION OF THE DRAWINGS

FIG. 1 is a flow chart outlining the clear-coat refinishing process.

FIGS. 2A-2F show the chemical structure of the components of the clear-coat used in the scratch repair composition.

FIGS. 3A-3D show the chemical structure of the components of the reducer used in the scratch repair composition.

FIG. 4A-4C show the chemical structure of the components of the hardener used in the scratch repair composition.

FIG. 5 is a bar char showing the relative proportions of the constituent ingredients of the scratch remover composition.

### DETAILED DESCRIPTION

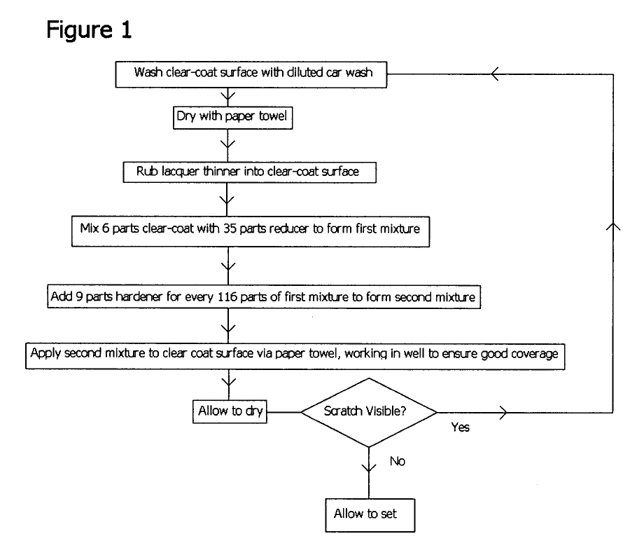

Referring to FIG. 1, the method of the present invention is illustrated as a flow chart. The steps of the process are in boxes starting from the top. The clear-coat surface is first washed with diluted car wash, then dried with a paper towel. After this it is further cleaned by rubbing lacquer thinner into the clear-coat surface. The first mixture, comprising clear coat and reducer in a 6:35 ratio is then prepared. Immediately prior to application hardener is added to the first mixture in a ratio of 9:116. This forms the second mixture which is the scratch remover composition. It is then applied carefully using a paper towel. There is ample time to ensure that the application is smooth due to the slow drying time. After drying the process can be done over if a visible scratch is still present. Once the scratch is no longer visible the composition is allowed to set.

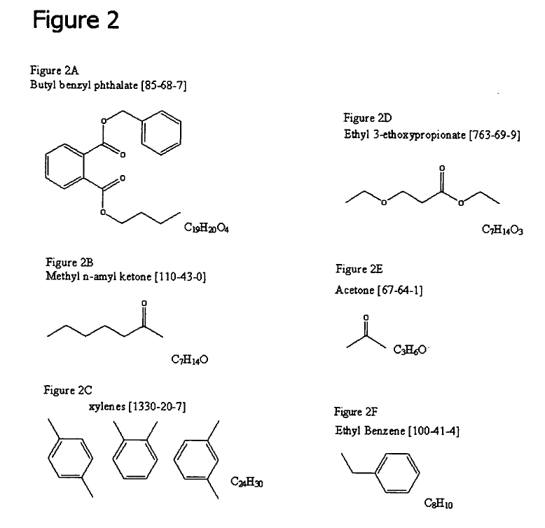

Referring to FIG. 2, the chemical structure of the components of the clear-coat used in the composition are shown. FIG. 2A shows the chemical structure Butyl Benzyl Phthalate which comprises 1% to 5% of the clear-coat part of the composition. FIG. 2B shows the chemical structure of Methyl N-Amyl Ketone which comprises 30-40% of the clear-coat. FIG. 2C shows the chemical structures of the Xylenes which comprise 1-10% of the clear coat. FIG. 2D shows Ethyl 3-Ethoxy Propionate which comprises 1-5% of the clear-coat. FIG. 2E shows the chemical structure of Acetone which comprises 1-10% of the clear-coat, and FIG. 2F shows the chemical structure of Ethyl Benzene which comprises less than 1% of the clear-coat. The reducer may also contain a light stabilizer with an unknown formula which comprises 1.0% to 3.0% of its volume. The specific stabilizer contained in the reducer is not critical to the functionality of the scratch remover formula.

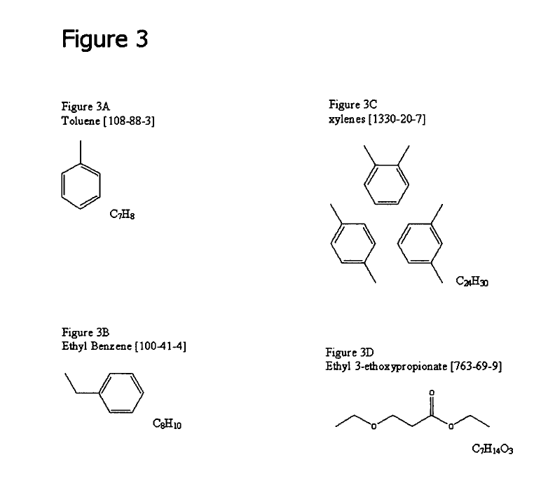

Referring to FIG. 3, the chemical structure of the components of the reducer used in the composition are shown. FIG. 3A shows the chemical structure of Tolulene which comprises 40% to 50% of the reducer. FIG. 3B shows the chemical structure of ethyl benzene which comprises 5.0% to 15% of the reducer. FIG. 3C shows the chemical structure of xylene which comprises 35-45% of the reducer. FIG. 3D shows the chemical structure of ethyl-3-ethxy propionate which comprises between 5% and 15% of the reducer.

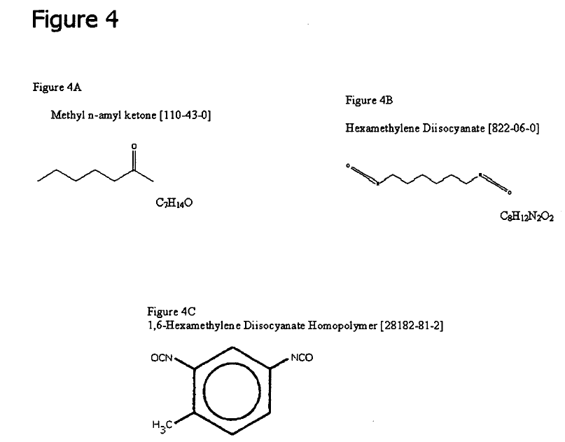

Referring to FIG. 4, the chemical structure of the components of the hardener used in the composition are shown. FIG. 4A shows the chemical structure of methyl n-amyl ketone which comprises 25% to 35% of the hardener. FIG. 4B shows the chemical structure of hexamethylene diisocyanate monomer which comprises less than 1.0% of the hardener. FIG. 4C shows the chemical structure of 1-6-hexamethylen diisocyanate homopolymer which comprises 65% to 75% of the hardener.

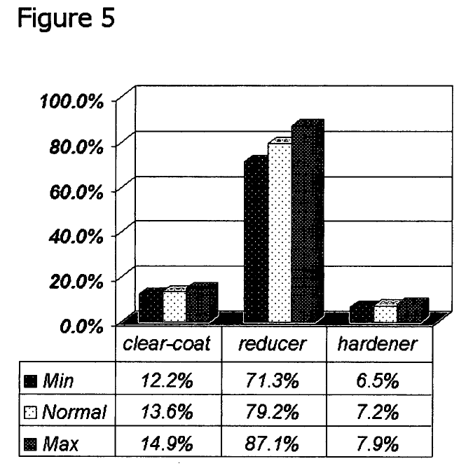

Referring to FIG. 5, in FIG. 5A the relative proportions of the composition ingredients are shown in a column chart. There are three columns for each ingredient of the composition, showing minimum (Min), normal, and maximum (Max) percentages for each ingredient in the composition. The leftmost group of columns show that the clear-coat makes up between 12.2% and 14.9% of the composition. The middle group of columns shows that the reducer makes up 71.3% and 87.1% of the composition. The rightmost group of columns shows that the hardener makes up between 6.5% and 7.9% of the composition.

The foregoing description should be considered as illustrative only, and not limiting. Other substantially equivalent compositions and techniques may be employed towards similar ends.

Various changes and modifications will occur to those skilled in the art, without departing from the true scope of the invention as defined in the above disclosure, and the following claims.

I claim:

1. A method for repairing scratches and for refinishing clear-coat surfaces, which employs a special composition having a clear-coat, a reducer, and a hardener in specific proportions, comprising the following steps:
a) wash and dry clear-coat surface with diluted car wash and a first absorbent towel;
b) further clean the clear-coat surface by rubbing-in lacquer thinner;
c) mix the clear-coat and the reducer in a volume ratio of approximately 6 to 35 respectively;
d) immediately prior to application, add the hardener to the above mixture in a volume ratio of approximately 9 units hardener to 116 units of the above mixture;
e) apply the resulting composition to the clear-coat surface using a second absorbent towel;
f) allow to dry;
g) determine whether the scratch is still visible;
h) repeat if necessary.

2. The method of claim 1, in which the special composition comprises a clear-coat, a reducer, and a hardener in the following proportions: between 12.2% and 14.9% clear-coat; between 71.3% and 87.1% reducer; between 6.5% and 7.9% hardener.

3. The method of claim 2, in which the special composition comprises a clear-coat, a reducer, and a hardener in substantially the following proportions: 13.6% clear-coat, 79.2% reducer, and 7.20% hardener.

4. The method of claim 1, in which the special composition contains a clear-coat comprising the following chemical compounds in the following proportions: butyl benzyl phthalate (1-5%), methyl n-amyl ketone (30-40%), xylene (1-10%), light stabilizer (1-3%), ethyl 3-ethoxy propionate (1-5%), acetone (1-10%), and ethyl benzene (<1%).

5. The method of claim 1, in which the special composition contains a reducer comprising the following chemical compounds in the following proportions: toluene (40-50%), ethyl benzene (5-15%), xylene (35-45%), and ethyl 3-ethoxy propionate (5-15%).

6. The method of claim 1, in which the special composition contains a hardener comprising the following chemical compounds in the following proportions: methyl amyl ketone (25-35%), hexamethylene diisocyanate monomer (<1.0%), and hexamethylene diisocyanate polyisocyanate (65.0-75.0%).

7. The method of claim 2, in which:
a) the special composition contains a clear-coat comprising the following chemical compounds in the following proportions: butyl benzyl phthalate (1-5%), methyl n-amyl ketone (30-40%), xylene (1-10%), light stabilizer (1-3%), ethyl 3-ethoxy propionate (1-5%), acetone (1-10%), and ethyl benzene (<1%);
b) the special composition contains a reducer comprising the following chemical compounds in the following proportions: toluene (40-50%), ethyl benzene (5-15%), xylene (35-45%), and ethyl 3-ethoxy propionate (5-15%);
c) the special composition contains a hardener comprising the following chemical compounds in the following proportions: methyl amyl ketone (25-35%), hexamethylene diisocyanate monomer (<1.0%), and hexamethylene diisocyanate polyisocyanate (65.0-75.0%).

8. A special composition for repairing scratches and for refinishing clear-coat surfaces, comprising a clear-coat, a reducer, and a hardener in the following proportions: between 12.2% and 14.9% clear-coat; between 71.3% and 87.1% reducer; between 6.5% and 7.9% hardener.

9. The composition of claim 8, in which the clear-coat comprises the following chemical compounds in the following proportions: butyl benzyl phthalate (1-5%), methyl n-amyl ketone (30-40%), xylene (1-10%), light stabilizer (1-3%), ethyl 3-ethoxy propionate (1-5%), acetone (1-10%), and ethyl benzene (<1%).

10. The composition of claim 8, in which the reducer comprises the following chemical compounds in the following proportions: toluene (40-50%), ethyl benzene (5-15%), xylene (35-45%), and ethyl 3-ethoxy propionate (5-15%).

11. The composition of claim 8, in which the hardener comprises the following chemical compounds in the following proportions: methyl amyl ketone (25-35%), hexamethylene diisocyanate monomer (<1.0%), and hexamethylene diisocyanate polyisocyanate (65.0-75.0%).

12. The composition of claim 9, in which:
a) the reducer comprises the following chemical compounds in the following proportions: toluene (40-50%), ethyl benzene (5-15%), xylene (35-45%), and ethyl 3-ethoxy propionate (5-15%);
b) the hardener comprises the following chemical compounds in the following proportions: methyl amyl ketone (25-35%), hexamethylene diisocyanate monomer (<1.0%), and hexamethylene diisocyanate polyisocyanate (65.0-75.0%).

13. The composition of claim 12, in which the special composition comprises substantially the following proportions: 13.6% clear-coat, 79.2% reducer, and 7.20% hardener.

14. The composition of claim 13, used in the following method for repairing scratches and for refinishing clear-coat surfaces:
a) wash and dry clear-coat surface with diluted car wash and a first absorbent towel;
b) further clean the clear-coat surface by rubbing-in lacquer thinner;
c) mix the clear-coat and the reducer in a volume ratio of approximately 6 to 35 respectively;
d) immediately prior to application, add the hardener to the above mixture in a volume ratio of approximately 9 units hardener to 116 units of the above mixture;
e) apply the resulting composition to the clear-coat surface using a second absorbent towel;
f) allow to dry;
g) determine whether the scratch is still visible;
h) repeat if necessary.
